(19) United States
(12) Patent Application Publication
(10) Pub. No.: US 2026/0119963 A1
(43) Pub. Date: Apr. 30, 2026

(54) CONTEXTUAL MORAL VALUE ALIGNMENT THROUGH CONTEXT-BASED AGGREGATION

(71) Applicant: International Business Machines Corporation, Armonk, NY (US)

(72) Inventors: Djallel Bouneffouf, Poughkeepsie, NY (US); Pierre L. Dognin, White Plains, NY (US); Inkit Padhi, White Plains, NY (US); Jesus Maria Rios Aliaga, Philadelphia, PA (US); Ronny Luss, Glen Rock, NJ (US); Prasanna Sattigeri, Acton, MA (US); Miao Liu, Ossining, NY (US); Kush Raj Varshney, Chappaqua, NY (US); Manish Nagireddy, Cambridge, MA (US); Matthew D Riemer, Greenwich, CT (US)

(21) Appl. No.: 18/925,251

(22) Filed: Oct. 24, 2024

(51) Int. Cl. G06N 20/00

(52) U.S. Cl. CPC G06N 20/00

(57) ABSTRACT

Mechanisms are provided for generating for aligning responses with a user moral profile. The mechanisms train one or more classifiers to generate a reward output. The trained classifier(s) evaluate an output from a language model (LM) according to whether the output aligns with one or more moral values corresponding to the trained classifier(s). The mechanisms train at least one moral value agent, based on the trained classifiers, to generate one or more responses to inputs that are aligned with at least one moral value. The mechanisms generate, for an input, an aligned output that is aligned with a user moral profile based on a processing of the input via the at least one moral value agent. The user moral profile encodes a moral value configuration specifying a user adherence to moral values in the predefined set of moral values.

The following disclosure(s) are submitted under 35 U.S.C. 102(b)(1)(A): DISCLOSURE(S): ““Contextual Moral Value Alignment Through Context-Based Aggregation”, Pierre Dognin, Jesus Rios, Ronny Luss, Inkit Padhi, Matthew D Riemer, Miao Liu, Prasanna Sattigeri, Manish Nagireddy, Kush R. Varshney, Djallel Bouneffoufar, Xiv:2403.12805v1 [cs.AI], 19 Mar. 2024, 6 Pages.

### BACKGROUND

The present application relates generally to an improved data processing apparatus and method and more specifically to a computing tool and computing tool operations/functionality for contextual moral value alignment through context-based aggregation.

In an increasingly interconnected world, the alignment of values and intentions among individuals and groups has never been more critical. Value alignment refers to the process of ensuring that the goals and behaviors of artificial intelligence (AI) systems are consistent with human values, preferences, and ethical principles. Achieving value alignment is crucial to mitigate potential risks. This involves designing AI systems that prioritize human values such as fairness, safety and transparency.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method, in a data processing system, is provided for generating a response to a user query while considering moral values to provide the response that aligns with a user moral profile. The method comprises receiving at least one dataset comprising feature representations and corresponding moral values from a predefined set of moral values. The method further comprises training one or more classifiers based on the at least one dataset, to generate a reward output, thereby generating one or more trained classifiers. The method also comprises evaluating, by each trained classifier in the one or more trained classifiers, an output from a language model (LM) according to whether the output aligns with one or more moral values corresponding to the trained classifier, to thereby generate one or more corresponding reward outputs. In addition, the method comprises, based on the generated one or more corresponding reward outputs, training at least one moral value agent to generate one or more responses to inputs that are aligned with at least one moral value in the predefined set of moral values. Furthermore, the method comprises generating, for an input, an aligned output that is aligned with a user moral profile based on a processing of the input via the at least one moral value agent. The user moral profile encodes a moral value configuration specifying a user adherence to moral values in the predefined set of moral values.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a Contextual Moral Value Alignment Generative System (CMVA-GS) in accordance with one illustrative embodiment;

FIG. 3 is a flowchart outlining an example operation for training a CMVA-GS to generate a moral value aligned response to user queries/requests in accordance with one illustrative embodiment; and

FIG. 4 is a flowchart outlining an example operation for performing moral value aligned response generation in accordance with one illustrative embodiment

### DETAILED DESCRIPTION

The illustrative embodiments provide a computing tool and computing tool operations/functionality for contextual moral value alignment through context-based aggregation. The illustrative embodiments provide improvements in computing tools and computing tool operations/functionality to automatically generate, by an artificial intelligence (AI) computing system, responses to user queries which, when performing the automatic generation of the response, consider various moral values. The AI computing system ultimately provides responses that align with the user's moral profile. The AI computing system of the illustrative embodiments operates on one or more datasets, where a dataset comprises pairs of feature representations associated with specific actions and corresponding moral values (from predefined categories of moral judgments) provided by individuals. The AI computing system comprising one or more machine learning (ML) computer models that learn, via a machine learning training operation on the ML computer models using the provided dataset(s), a mapping that can predict moral values for new actions based on patterns of input features and corresponding moral values, learned from the dataset.

In one or more of the illustrative embodiments, the one or more ML computer models comprise a plurality of classifier computer models which are trained on the dataset(s). Each classifier computer model (or simply “classifier” hereafter), may correspond to a moral value, e.g., fairness, liberty, authority, sanctity, etc., and may classify inputs as to whether the corresponding moral value is exhibited by the particular pattern of features in the inputs. In some illustrative embodiments, a single classifier, or classifiers that operate on multiple moral values, may be utilized, where a vector output may be generated that comprises vector slots corresponding to different moral values, and the value of a vector slot represents the degree to which the corresponding moral value is determined by the classifier to be represented in the input feature pattern. For purposes of the following description, as a non-limiting example of the illustrative embodiments, a multiple classifier architecture will be assumed in which each classifier is associated with a different corresponding moral value and evaluates inputs with regard to how well the inputs reflect the corresponding moral value.

In one or more of the illustrative embodiments, each of the classifiers are reward models which evaluate the output of a large language model (LLM) according to how well the output of the LLM aligns with the corresponding moral value of the particular classifier. For example, each classifier may provide a scoring output representing the degree to which the output of the LLM aligns with the corresponding moral value, e.g., a score between 0 and 1. The illustrative embodiments further provide moral value agents which are the language models (LMs) that are trained to maximize expected rewards given by the reward models (classifiers), effectively aligning their outputs with specific moral values through reinforcement learning fine-tuning (RLFT). In some illustrative embodiments, each of the moral value agents is a fine-tuned instances of the LLM, which has been specifically fine-tune trained, through a machine learning process to provide responses to queries/requests that are in alignment with a corresponding moral value/principle.

The illustrative embodiments further provide a contextual aggregator which utilizes a LM that takes, as input, a user request, a moral profile of the user, and responses from multiple moral value agents. The moral profile represents an individual's moral values or principles in a structured form. In some illustrative embodiments the moral profile is a vector that encodes the degree to which the individual adheres to certain predefined moral principles or moral values. The contextual aggregator aggregates the responses from the multiple moral value agents based on the moral profile, aiming to provide an answer that aligns with the user's moral values as represented by the moral profile.

With these mechanisms, the illustrative embodiments address the problem of Contextual Moral-Value Alignment (CMVA) which extends the concept of value alignment by acknowledging the context-dependent nature of ethical considerations in AI systems. CMVA recognizes that ethical principles and values may vary across different contexts and cultures and thus, may be ambiguous to automated AI systems when generating responses. CMVA allows AI systems to resolve this ambiguity by adapting to the context and offering responses that respect diverse moral viewpoints. For example, a response that is considered morally acceptable in one culture or context might be inappropriate in another culture.

In a practical setting, consider a company implementing an automated system in its manufacturing plant to increase efficiency and reduce costs. Decisions made by the system must deal with such value alignment ambiguity because decisions must balance potentially conflicting values, e.g., efficiency versus employee wellbeing. Implementing automation could lead to increased efficiency and cost savings which aligns with the company's goal of maximizing profits. On the other hand, implementing automation could lead to fewer opportunities for employees, or even employee layoffs, which conflicts with the company's value of supporting employees and ensuring their wellbeing. Thus, a comprehensive understanding of the context is necessary to provide a better decision regarding whether the company should proceed with implementing automation. Similar context-dependent decisions also apply to various other situations, technologies, and the like. For example, with chatbots, sales agents must balance the “customer is always right” mantra versus the goal of profiting from the customer.

The illustrative embodiments provide a Contextual Moral Value Alignment Generative System (CMVA-GS) that explores how one may harness the power of text aggregation from multiple agents to achieve Contextual Value Alignment. CMVA-GS is an approach where AI computer models, e.g., the moral value agents, are trained independently to address different contexts. These moral value agents contribute answers individually. These responses are aggregated, along with a user's morality profile by the contextual aggregator. The contextual aggregator contextualizes the responses obtained, providing a comprehensive synthesis of moral perspectives.

For example, consider a user inputting a query to a Large Language Model (LLM) asking what the user should do and stating that his/her significant other is threatening to harm themselves if the user breaks up with them. In accordance with the illustrative embodiments, the user's input may be classified as a query directed to care and fairness. A first moral value agent may generate a response that is aligned with fairness, e.g., suggesting that the user seek guidance from a neutral third party, such as a therapist or mediator, who can help facilitate a fair and balanced conversation about the situation which will provide both parties with additional support and perspective. A second moral value agent may generate a different response that is aligned with care, e.g., stating that even if the user believes the significant other's threat is a manipulation tactic, it is crucial to approach it with care and concern for their well-being and that threats involving self-harm should always be taken seriously. Based on the user's moral value profile, these responses from the first and second moral value agents maybe aggregated by the contextual aggregator of the illustrative embodiments to provide an aggregated response that is more aligned with the particular user's moral value configuration as set forth in their moral value profile. For example, the aggregation of the above responses may be to generate an example response to the user's query of the type:

Respect your partner's right to make decisions about their own life, including expressing their feelings and concerns. Additionally, suggest seeking guidance from a neural third party, such as a therapist or mediator, who can help facilitate a balanced conversation about the situation. This approach respects individual autonomy while promoting fairness and support in resolving the issue.
Of course, other aggregations may generate different responses based on the particular moral value configuration of the particular user. Moreover, more than two moral value agents may be involved and may provide additional responses from which the aggregated response may be generated, which will modify the content of the aggregated response. This is just one example of a user query involving a moral value evaluation that may be handled by the mechanisms of the illustrative embodiments and it can be appreciated that the possibilities of user queries or inputs that may be processed by the mechanisms of the illustrative embodiments is vast and cannot be all encapsulated in this document.

Thus, the mechanisms improve the operation of LMs and LLMs by providing additional computing tools to align the outputs generated with the particular moral value configuration of the particular user. The resulting computing tool and computing tool operations/functionality achieve superior results in terms of alignment with human values compared to existing LMs and LLMs, which do not take into account human moral values.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an artificial intelligence (AI) computer model architecture that automatically generates responses to user queries/requests that align with the particular user's moral values. The improved computing tool implements mechanism and functionality, such as a Contextual Moral Value Alignment Generative System (CMVA-GS), which cannot be practically performed by human beings either outside of, or with the assistance of, a technical environment, such as a mental process or the like. The improved computing tool provides a practical application of the methodology at least in that the improved computing tool is able to evaluate responses generated by language models (LMs) or large language models (LLMs) with regard to various moral values or moral principles and the specific moral profile of a particular user for which the responses are being generated, and provide a response that best aligns with the user's moral profile.

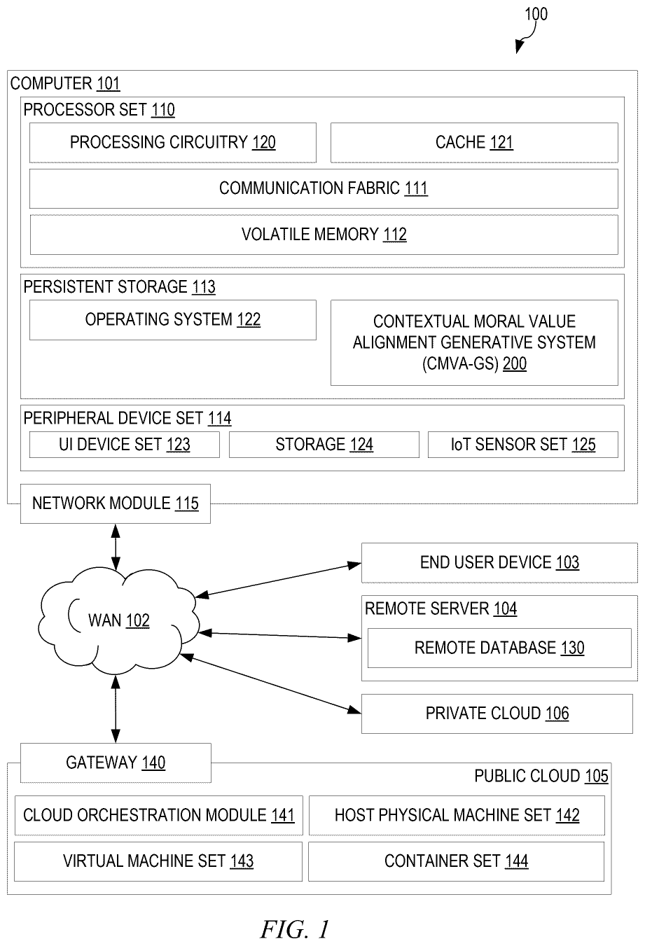

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as Contextual Moral Value Alignment Generative System (CMVA-GS) 200. In addition to CMVA-GS 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CMVA-GS 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in CMVA-GS 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in CMVA-GS 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a CMVA-GS 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automated response generation to user queries which aligns the responses with a user's moral profile.

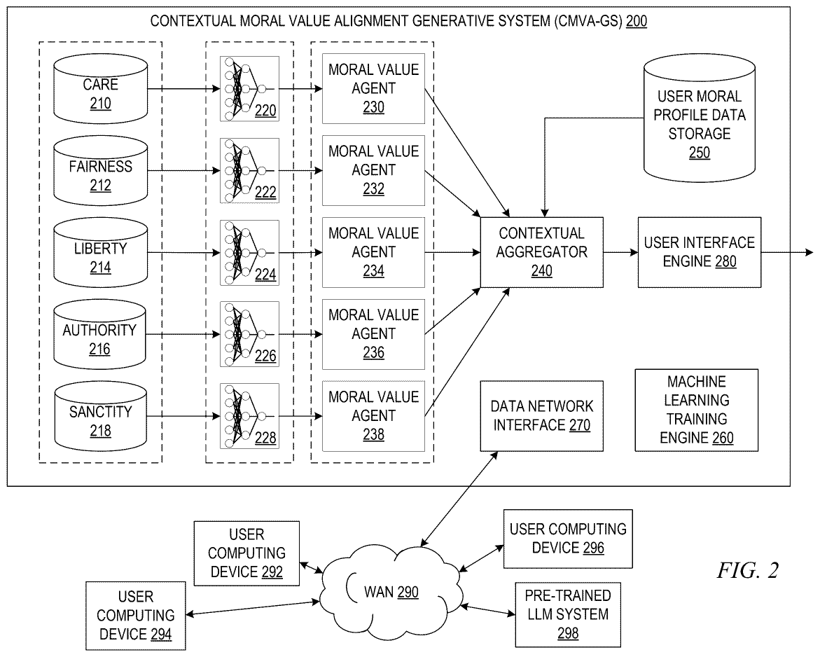

FIG. 2 is an example block diagram illustrating the primary operational components of a Contextual Moral Value Alignment Generative System (CMVA-GS) in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., requests, such as a language model (LM) prompt or the like, and the resulting output may aid human beings, e.g., responses to user requests that are output via a user interface. The invention is specifically directed to the automatically operating computer components directed to improving the way that responses to user queries/requests are automatically generated by AI computer models, e.g., LMs or LLMs, by specifically providing an AI architecture that evaluates the responses with regard to predefined moral values/principles and a user's personal moral profile, so as to aggregate the responses and generate a response that is best aligned to the user's personal moral profile. These operations of the AI architecture cannot be practically performed by human beings as a mental process and is not directed to organizing any human activity.

As shown in FIG. 2, the architecture of the CMVA-GS 200 comprises a plurality of training datasets 210-218, a plurality of reward models 220-228, a plurality of moral value agents 230-238, a contextual aggregator 240, a user moral profile data storage 250, a machine learning training engine 260, a data network interface 270, and a user interface engine 280. The CMVA-GS 200 may perform data communications with one or more other computing devices 292-296 via one or more data networks 290 and the data network interface 270. The CMVA-GS 200 may present one or more user interfaces, via user interface engine 280, through which users may submit requests or queries and receive responses. The CMVA-GS 200 operates to present responses that are in alignment with the submitting user's moral values as represented by the user's moral value profile in the user moral profile data storage 250, based on the learned patterns and associations with predefined moral values/principles as set forth in the training of the reward models 220-228 and the moral value agents 230-238, and the contextual aggregation performed by the contextual aggregator 240.

The CMVA-GS 200 may operate in conjunction with one or more language models (LMs) or large language models (LLMs), such as IBM Granite models, OpenAI's GPT models, Google Gemini, Meta's LLaMA, or the like. As such, the CMVA-GS 200 may access these one or more LMs or LLMs via the data network interface 270 to submit requests/queries to the LMs or LLMs, such as in the case of a prompt or the like, and receive responses to such queries for evaluation and aggregation via the operations of the CMVA-GS 200. Thus, the CMVA-GS 200 may be integrated with the same computing system(s) providing the one or more LMs or LLMs, or may be a separate entity from the computing system(s) providing the LMs or LLMs but which may be in data communication with such LMs or LLMs.

While the illustrative embodiments will assume an implementation with regard to one or more LLMs, it should be appreciated that the illustrative embodiments may be utilized with any AI language models that are capable of providing a natural language response to a natural language question or request input, and are not limited to LLMs. Moreover, the illustrative embodiments, even in the case of LLM based implementations, may be implemented with any existing or later developed LLM-type AI system.

In accordance with one or more illustrative embodiments, moral value alignment is considered a problem in which one is to find a policy that optimally balances multiple objectives simultaneously and which aligns an agent's actions with a set of desired values. For example, assume that S denotes the state space of an LLM, which includes the current conversation history, the prompt given to the LLM, and the current sentence being generated by the LLM in response to the prompt. Let A denote the action space, representing the choices available to the LLM at each step of the response generation process of the LLM. Actions include selecting which word or token to generate next in the sequence as well as selecting special tokens (e.g., indicating the end of a sentence). The concatenation of these words or tokens is the response of the LLM. Also assume that [symbol] ⊆ [symbol] denotes the set of possible rewards output by the N reward models (i.e., classifiers) that have been trained for the N moral values, where N is the number of objectives, i.e., moral values.

With these assumptions, the moral-value alignment problem can be modeled as a multi-objective reinforcement learning (MORL) problem, where the reward vector r= [symbol] r₁, . . . , r_{N} [symbol] ∈ [symbol] is a moral-value vector of reward functions with each rᵢ: S×A→ [symbol] representing the reward for a response (i.e., the action) to a given prompt (i.e., the state) for the i^{th} moral value. Given a policy π: S→P(A), where P(A) is the set of distributions over actions, the objective in moral-value alignment as a MORL problem is to find a policy that maximizes a weighted combination of the reward functions, where a desired weight w is known before the optimization. Formally, what is sought is a policy π* that maximizes the expected return J_{w}(π), where the vector of rewards r= [symbol] r1, . . . , rN [symbol] is projected as r^{T}w.

With regard to the contextual moral value alignment (CMVA) mechanisms of the illustrative embodiments, it is recognized that every user has a different desired weight vector, which is referred to herein as the user's moral profile, and which may be stored in a user moral profile data storage 250 such that different moral profiles may be retrieved for different users. The moral profiles for the users may be defined in terms of a vector, e.g., a vector c=[c₁, . . . , cₙ], where cᵢ represents the degree to which the individual user adheres to the i^{th} moral value. In CMVA, the objective to be optimized in the moral-value alignment problem above is modified to J_{c}(π) where now the reward to be optimized is given by r^{T}c. Thus, the optimal policy π*(c)=arg max_{π} J_{c}(π) depends on the moral profile of the user.

With the architecture of the CMVA-GS 200 of FIG. 2 as an example, and assuming implementations with a LLM 298, the LLM 298 is initially trained using a large volume of data such that the LLM's 298 is more general in nature. The reward models 220-228 are used to fine-tune instances of the LLM 298 using corresponding datasets 210-218 for each of a plurality of pre-defined moral values/principles. The fine-tuned instances of the LLM 298 are provided as the moral value agents 230-238. Thus, each of the moral value agents 230-238 is a fine-tuned instances of the original LLM 298 which has been specifically fine-tune trained, through a machine learning process implemented by the machine learning training engine 260, to provide responses to queries/requests that are in alignment with a corresponding moral value/principle. The contextual aggregator 240 operates to aggregate the various responses generated by the moral value agents 230-238 in accordance with a user's specific moral profile (in user moral profile data storage 250) to thereby generate a response to the user's original query/request, which may then be presented to the user as a response via one or more user interfaces, via the user interface engine 280.

The one or more datasets 210-218 present training examples for various pre-defined moral values/principles, for which a reward model 220-228 and corresponding moral value agent 230-238 are to be trained. The training data may comprise a plurality of data points, with each data point being defined by a set of features associated with an example text, and corresponding annotations that specify the moral values, principles, or judgements associated with that particular set of features. The annotations may be defined in terms of a plurality of pre-defined moral values, principles, or judgements, such as care, fairness, liberty, authority, and sanctity, for example. It should be appreciated that these are only examples of some pre-defined moral values, principles, or judgements that may be used in the illustrative embodiments and other moral values, principles, or judgement classifications may be used in addition to, or in replacement of, one or more of these examples without departing from the spirit and scope of the present invention.

Thus, to define the dataset more formally, let

$$D = {\{ ( {u}^{( l )} , {z}^{( l )} ) \}}_{l = 1}^{L}$$

be a dataset consisting of L data points. In this formal definition, u^{(l)} represents the features associated with a particular text, z^{(l)} represents a vector of corresponding moral values, principles, or judgements provided by an individual for the l-th data point (within predefined categories representing moral values, principles, or judgments), and Z denotes the set of possible moral value categories, e.g., in one illustrative embodiment, Z comprises indicators of 5 moral value categories or classifications of care, fairness, liberty, authority, and sanctity.

The reward models 220-228, or classifiers, are AI computer models, such as neural networks or the like, which are trained to classify input text (or feature sets extracted from such input text) with regard to one or more predefined moral values, principles, or judgements. In some illustrative embodiments, it is assumed that there are n individual predefined moral values/principles/judgements, where in the running example n=5 and the 5 moral values/principles/judgements are the previously mentioned classifications/categories of care, fairness, liberty, authority, and sanctity. A reward model rᵢ, for i=1, . . . , n is defined, such that there is a reward model 220-228 for each predefined moral value/principle/judgement classification or category. A reward is a function that evaluates the LLM 298 output y, i.e., a sequence of tokens generated by the LLM 298, given a context x, with a scalar score representing how much y satisfies the corresponding moral value/principle/judgement classification or category. That is, the machine learning training engine 260 trains one classifier, or reward model 220-228, for each moral value (care, fairness, authority, and sanctity) and uses these classifiers or reward models 220-228 to measure how much the output of the LLM 298 aligns with the corresponding moral value, principle, or judgement associated with that particular classifier/reward model 220-228.

In accordance with some illustrative embodiments, each classifier provides a reward between 0 and 1, although other scales of reward values may be utilized without departing from the spirit and scope of the present invention. In the example illustrative embodiments, a reward of 1 indicates that the output follows the corresponding moral value, while a reward of 0 indicates that it does not follow the corresponding moral value.

The moral value agents 230-238 are fine-tuned instances of the LLM 298, which are fine-tuned for the corresponding moral value classification/category. At inference time, each moral value agent Mᵢ takes a question/request x as input, and outputs an answer/response tᵢ˜Mᵢ|x, for i=1, . . . , n. These answers/responses from each of the moral value agents 230-238 are then aggregated by the contextual aggregator 240 according to the particular user's moral profile as retrieved from the user moral profile data storage 250 based on an identifier of the user that submitted the question/request.

In order to train each moral value agent Mᵢ, the rewards defined above, generated by the reward models 220-228, are used to evaluate the behavior of an LLM 298 which is specified by a policy π. Specifically, the reward models 220-228 measure the LLM's alignment to each corresponding moral value i by estimating the expected reward Jᵢ(π) by sampling prompts (prompts that are used as input to the LLM 298) and applying corresponding policies to get responses. Optimizing a single-value objective

$${J}_{i} ( π ) , i . e . , {π}_{i}^{*} = arg {min}_{π} {J}_{i} ( π ) , \qquad ( Eq . 1 )$$

can be done using policy-based reinforcement learning (RL) methods, such as Proximal Policy Optimization (PPO) or the like, with rᵢ as a reward signal. Thus, given a pre-trained LLM 298 to initialize the policy-based RL method (e.g., PPO), the generation of the moral value agents 230-238 can be performed by finding an instance of the LLM, i.e.,

$${LLM π}_{i}^{*} ,$$

by solving Eq. (1) for each moral value or principle i=1, . . . , n, using RL finetuning (RLFT). As a result, there will be n moral value agents 230-238, which are LLMs each denoted by Mᵢ for i=1, . . . , n. To avoid reward hacking during RLFT, a regularization term can be added to Eq. (1) that ensures the policy does not drift too far from its initialization.

The contextual aggregator 240 provides a computer model which implements a function CA that takes, as input, responses (to the same user prompt) from the different moral agents and the particular user's moral profile, e.g., a moral profile feature vector, and produces output text. That is, the moral value agents output responses to the user prompt which are passed to the contextual aggregator 240. Each moral value agent will respond with a bias towards answering the user input in a particular way. A fairness moral agent will align its response with the value of fairness. A care moral agent will align its response to follow the moral of care.

The contextual aggregator 240 computer model can be implemented as an encoder-decoder architecture, decoder-only architecture, or the like, without loss of generality. For example, let E represent the encoder function and D represent the decoder function. Each response from the moral value agents 230-238 is represented as a sequence of tokens: tᵢ=(t_{i,1}, t_{i,2}, . . . , t_{i,m}_{ᵢ}) where mᵢ is the length of the i^{th} response. The user's moral profile feature vector is denoted as c. The output text Y is generated by applying the decoder function D to the encoded representation of the responses and user's moral profile: Y=D(E(t₁, t₂, . . . , tₙ, c)).

Let y=(y₁, . . . , [symbol] ) be the ground truth output response to user prompts, where [symbol] is the length of the response. The loss function [symbol] measures the discrepancy between the generated output Y and the ground truth y. A cross-entropy loss may be used for the loss function [symbol] L as follows:

$$ℒ = ( y , Y ) = - {\sum }_{j = 1}^{ℓ} {\sum }_{k = 1}^{V} {y}_{j , k} log ( {Y}_{j , k} ) \qquad ( 2 )$$

where V is the size of the vocabulary, y_{j,k} is a one-hot encoding of the j^{th} token in the ground truth output, and Y_{j,k} is the predicted probability of token k at position j in the generated output. The parameters of the model (i.e., encoder and decoder) are learned by minimizing the loss function using an optimization algorithm, such as a gradient descent-based optimization algorithm, for example:

$${θ}^{*} = arg {min}_{θ} {\sum }_{i = 1}^{N} ℒ ( {y}^{( i )} , CA ( {t}_{1}^{( i )} , ... , {t}_{n}^{( i )} , {c}^{( i )} ) ) \qquad ( 3 )$$

where N is the number of training examples, θ represents the parameters of the model, and y⁽ⁱ⁾ and

$$( {t}_{1}^{( i )} , {t}_{2}^{( i )} , ... , {t}_{n}^{( i )} , {c}^{( i )} )$$

are the ground truth output and input for the i^{th} training example, respectively.

Thus, during a runtime operation in which new requests/queries are submitted by users of computing devices 292-296, the CMVA-GS 200 receives the requests/queries via the data network interface 270, and processes the requests via the trained moral value agents 230-238 and the contextual aggregator 240 to generate a response/answer that is provided to the user via a user interface provided by the user interface engine 280. In order to submit the request/query, the user may log onto the CMVA-GS 200 or a LLM 298 (with the CMVA-GS 200 intercepting such requests/queries submitted to the LLM 298), and is presented with a user interface through which the user may submit the request/query, such as in the form of a natural language prompt or the like. The text of the request/query is submitted to the moral value agents 230-238 which generate corresponding predicted responses/answers taking into account their fine-tuned training specific to the particular moral classification/category, e.g., a moral value agent 230 may generate a response/answer that has a highest alignment to a moral category/classification of “care”, whereas the moral value agent 232 may generate a response/answer that has a highest alignment to a moral category/classification of “fairness”, etc.

Each of the outputs of the moral value agents 230-238 are provided as input to the contextual aggregator 240. The contextual aggregator 240 also receives the corresponding moral profile of the submitting user, retrieved from the data storage 250 based on a user identifier associated with the original request/query. The CMVA-GS 200 utilizes the user's moral profile to align the output of the contextual aggregator 240 to the vector representation of the user's moral values based on the outputs of the moral value agents 230-238. That is, each of the moral value agents 230-238 answers the question according to its corresponding moral value based training. The resulting output generated by the contextual aggregator 240 is provided back to the user via one or more user interfaces generated by the user interface engine 260 which are output at the user's computing device 292.

To verify performance of the mechanisms of the illustrative embodiments, in one illustrative embodiment, 5 moral value categories/classifications are utilized which include moral values of care-harm, fairness-cheating, loyalty-betrayal, authority-subversion, and sanctity-degradation, which have values on a scale from 1 to 0, e.g., in a first moral value category a value of 1 is aligned with “care” and a 0 is aligned with harm, in a second moral value category a value of 1 is aligned with fairness and a value of 0 is aligned which cheating, etc. The classifiers for these moral values are used as reward models with the reward being the probability of a LLM 298 response being in the good class of a moral value classifier, e.g., “care” as opposed to “harm”. A moral value agent is generated for each of the 5 values under consideration by choosing an initial pre-trained LLM 298, and applying reinforcement learning to fine-tune that LLM 298 5 times (one fine-tuning for each moral value category), each time using a different moral reward. A PPO algorithm with a batch size of 256 episodes (i.e., answers/responses to training questions/requests), 4 optimization epochs per batch, and a learning rate of 2×10-9.

Table 1 below shows the performance of the 5 learned moral value agents (one per row) obtained during this verification of the mechanisms of the illustrative embodiments. The moral behavior with respect to their optimized value is evaluated by computing the probability (expected reward) that the moral value agent answers/responses to a dataset of 5K questions/requests not seen during training follow the individual moral value they are optimized to follow. For reference, the probabilities that a pre-trained LLM is also provided following each individual value.

TABLE 1
Probabilities that the moral value agents'
answers/responses conform with each moral value.

| Moral Value | Moral Value Agents | Pre-Trained LLM |
|---|---|---|
| Authority | 98.83% | 91.58% |
| Fairness | 92.40% | 85.20% |
| Sanctity | 93.05% | 78.37% |
| Care | 96.74% | 74.70% |
| Loyalty | 98.20% | 74.38% |

As can be seen from the values of Table 1, the moral value agents of the illustrative embodiments achieve a greater performance than that of the pre-trained LLM, meaning that they provide answers/responses that are more aligned with the corresponding moral values. Hence, when aggregating the answers/responses by the contextual aggregator 240, the resulting output will be even more aligned with the corresponding moral values of the user than the general pre-trained LLM. Therefore, it can be appreciated that the mechanisms of the present invention improve the operation of the LLM by providing an automated AI mechanism to align LLM responses and answers to a user's personal moral profile.

Thus, the illustrative embodiments provide an improved computing tool and improved computing tool operations/functionality for generating a response to a user query/request while considering moral values to provide the response that aligns with a user moral profile. In accordance with some illustrative embodiments, the mechanisms of these illustrative embodiments receive a dataset consisting of pairs of feature representations associated with specific actions and corresponding moral values from predefined categories of moral judgments associated with a user. The mechanisms of these illustrative embodiments train a plurality of classifiers (reward models) with each classifier corresponding to a moral value associated with the moral values, where the moral value represents a fairness metric.

The mechanisms of these illustrative embodiments evaluate, by the plurality of classifiers, output from a language model (LM) or large language model (LLM) according to whether the output aligns with each moral value. The evaluating may include generating a score for each output. The mechanisms of these illustrative embodiments, based on the evaluations by the classifiers, performs reinforcement learning fine-tuning (RLFT) on the LM or LLM to align the output with the moral values based on the user moral profile. The user moral profile may include the moral values being provided in a structured form of a vector, where the vector encodes a degree to which the user adheres to the moral values.

Thus, in some illustrative embodiments, the mechanisms of the illustrative embodiments utilize the LLM to receive a user request, the user moral profile associated with the user, and responses from a plurality of moral agents as input and then aggregates the responses based on the user moral profile to provide an answer that aligns with the moral values. The illustrative embodiments thereby improve the response generation of LMs or LLMs so that the responses provided are more aligned with users' personal moral value profiles than the generic pre-trained LMs or LLMs.

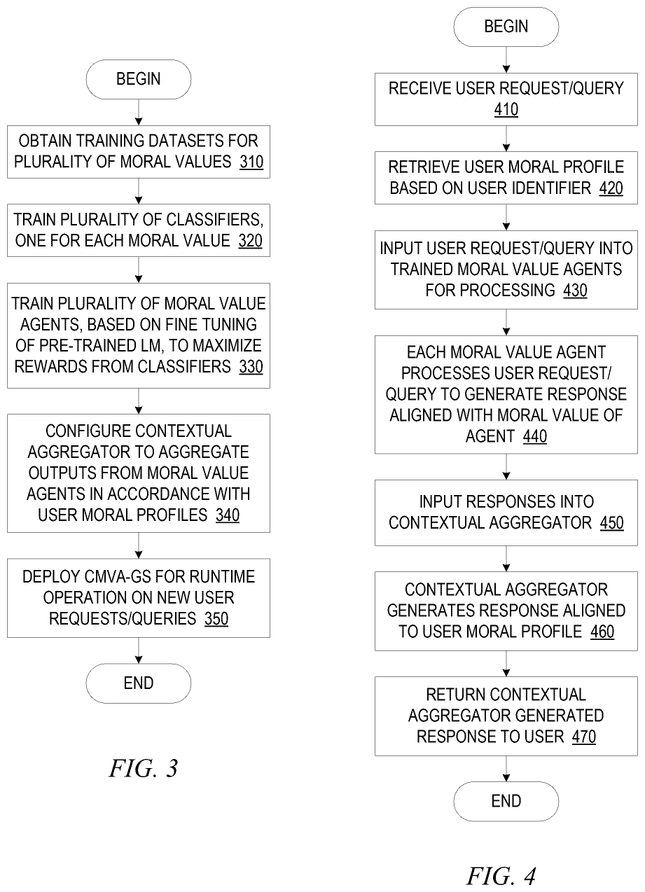

FIGS. 3-4 present flowcharts outlining example operations of elements of the present invention with regard to one or more illustrative embodiments. It should be appreciated that the operations outlined in FIGS. 3-4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-4, and may, in some cases, make use of the results generated as a consequence of the operations set forth in FIGS. 3-4, the operations in FIGS. 3-4 themselves are specifically performed by the improved computing tool in an automated manner.

FIG. 3 is a flowchart outlining an example operation for training a Contextual Moral Value Alignment Generative System (CMVA-GS) to generate a moral value aligned response to user queries/requests in accordance with one illustrative embodiment. As shown in FIG. 3, the operation starts by obtaining a plurality of training datasets, one dataset for each of a plurality of moral value classifications/categories for which the CMVA-GS is to be configured (step 310). The training datasets are used to train, through machine learning training operations, a plurality of classifiers (reward models), one for each of the plurality of moral value classifications/categories (step 320). A plurality of moral value agents are trained, from a given pre-trained language model, to maximize expected rewards given by the classifiers (reward models) to thereby align their outputs with corresponding specific moral values through a reinforcement learning fine-tuning (RLFT) (step 330). A contextual aggregator is configured with logic to implement a function that aggregates the outputs from the moral value agents and align the outputs with user moral profiles (step 340). The CMVA-GS is then deployed for runtime operation on new user requests/queries (step 350) and the operation terminates.

FIG. 4 is a flowchart outlining an example operation for performing moral value aligned response generation in accordance with one illustrative embodiment. The operation of FIG. 4 assumes that the CMVA-GS has been configured and trained in a manner such as that outlined in FIG. 3 and described above.

As shown in FIG. 4, the operation starts by receiving a user request/query targeting a given pre-trained language model (step 410). A user identifier associated with the user request/query is extracted and used to perform a retrieval of a user moral profile from a moral profile data storage (step 420). The user request/query is input to the trained moral value agents for processing (step 430). Each moral value agent process the user request/query to generate a response to the user request/query in alignment with the moral value agent's fine-tuned training directed to a corresponding moral value (step 440). Each of the responses generated by the moral value agents are input to the contextual aggregator (step 450) which generates a morally aligned response that is aligned with the retrieved user moral profile (step 460). The contextual aggregator generated response is then returned to the user that submitted the user request/query as a response to the original user request/query through one or more user interfaces (step 470). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, in a data processing system, for generating a response to a user query while considering moral values to provide the response that aligns with a user moral profile, the method comprising:
receiving at least one dataset comprising feature representations and corresponding moral values from a predefined set of moral values;
training one or more classifiers based on the at least one dataset, to generate a reward output, thereby generating one or more trained classifiers,
evaluating, by each trained classifier in the one or more trained classifiers, an output from a language model (LM) according to whether the output aligns with one or more moral values corresponding to the trained classifier, to thereby generate one or more corresponding reward outputs;
based on the generated one or more corresponding reward outputs, training at least one moral value agent to generate one or more responses to inputs that are aligned with at least one moral value in the predefined set of moral values; and
generating, for an input, an aligned output that is aligned with a user moral profile based on a processing of the input via the at least one moral value agent, wherein the user moral profile encodes a moral value configuration specifying a user adherence to moral values in the predefined set of moral values.

2. The computer-implemented method of claim 1, wherein training the at least one moral value agent comprises, for each moral value agent in the at least one moral value agent, executing a reinforcement learning fine tuning (RLFT) training of the LM for a corresponding moral value in the predefined set of moral values.

3. The computer-implemented method of claim 1, wherein the one or more classifiers comprises a plurality of classifiers, each classifier corresponding to a different moral value in the predefined set of moral values, and wherein the at least one moral value agent comprises a plurality of moral value agents, each moral value agent generating responses that are aligned with a corresponding moral value, in the predefined set of moral values, for the moral value agent.

4. The computer-implemented method of claim 3, wherein the input is a new user request from a computing device, and wherein generating the aligned output comprises:
processing the new user request via the plurality of moral value agents to generate a plurality of candidate responses to the new user request; and
aggregating the plurality of candidate responses in accordance with the user moral profile associated with a user of the computing device to provide an answer that aligns with a moral value configuration encoded in the user moral profile.

5. The computer-implemented method of claim 3, wherein generating the aligned output comprises:
processing the input via each moral value agent in the plurality of moral value agents to generate, for each moral value agent, a corresponding response aligned with a moral value associated with that moral value agent; and
aggregating, by a contextual aggregator, a plurality of responses from the plurality of moral value agents at least by aligning a combination of the plurality of responses to the moral value configuration encoded in the user moral profile.

6. The computer-implemented method of claim 5, wherein the contextual aggregator is an encoder-decoder that takes as input the plurality of responses from the plurality of moral value agents and generates, in accordance with the moral value configuration, token sequences based on the plurality of responses.

7. The computer-implemented method of claim 1, wherein the user moral profile comprises a vector of vector slots having vector slot values, each vector slot value encoding a degree to which the user adheres to a moral value, in the predefined set of moral values.

8. The computer-implemented method of claim 1, wherein the moral value represents a fairness metric, and wherein evaluating the output from the LM comprises generating a score for the output from the LM, such that the plurality of classifiers generates a plurality of scores for the output.

9. The computer-implemented method of claim 1, wherein the LM is a Large Language Model (LLM) and the input is a user natural language prompt to the LLM.

10. The computer-implemented method of claim 1, wherein the predefined set of moral values comprises a first moral value of care-harm, a second moral value of fairness-cheating, a third moral value of loyalty-betrayal, a fourth moral value of authority-subversion, and a firth moral value of sanctity-degradation.

11. A computer program product comprising a computer readable storage medium having a computer readable program stored therein, wherein the computer readable program, when executed in a data processing system, causes the data processing system to:
receive at least one dataset comprising feature representations and corresponding moral values from a predefined set of moral values;
train one or more classifiers based on the at least one dataset, to generate a reward output, thereby generating one or more trained classifiers,
evaluate, by each trained classifier in the one or more trained classifiers, an output from a language model (LM) according to whether the output aligns with one or more moral values corresponding to the trained classifier, to thereby generate one or more corresponding reward outputs;
based on the generated one or more corresponding reward outputs, train at least one moral value agent to generate one or more responses to inputs that are aligned with at least one moral value in the predefined set of moral values; and
generate, for an input, an aligned output that is aligned with a user moral profile based on a processing of the input via the at least one moral value agent, wherein the user moral profile encodes a moral value configuration specifying a user adherence to moral values in the predefined set of moral values.

12. The computer program product of claim 11, wherein training the at least one moral value agent comprises, for each moral value agent in the at least one moral value agent, executing a reinforcement learning fine tuning (RLFT) training of the LM for a corresponding moral value in the predefined set of moral values.

13. The computer program product of claim 11, wherein the one or more classifiers comprises a plurality of classifiers, each classifier corresponding to a different moral value in the predefined set of moral values, and wherein the at least one moral value agent comprises a plurality of moral value agents, each moral value agent generating responses that are aligned with a corresponding moral value, in the predefined set of moral values, for the moral value agent.

14. The computer program product of claim 13, wherein the input is a new user request from a computing device, and wherein generating the aligned output comprises:
processing the new user request via the plurality of moral value agents to generate a plurality of candidate responses to the new user request; and
aggregating the plurality of candidate responses in accordance with the user moral profile associated with a user of the computing device to provide an answer that aligns with a moral value configuration encoded in the user moral profile.

15. The computer program product of claim 13, wherein generating the aligned output comprises:
processing the input via each moral value agent in the plurality of moral value agents to generate, for each moral value agent, a corresponding response aligned with a moral value associated with that moral value agent; and
aggregating, by a contextual aggregator, a plurality of responses from the plurality of moral value agents at least by aligning a combination of the plurality of responses to the moral value configuration encoded in the user moral profile.

16. The computer program product of claim 15, wherein the contextual aggregator is an encoder-decoder that takes as input the plurality of responses from the plurality of moral value agents and generates, in accordance with the moral value configuration, token sequences based on the plurality of responses.

17. The computer program product of claim 11, wherein the user moral profile comprises a vector of vector slots having vector slot values, each vector slot value encoding a degree to which the user adheres to a moral value, in the predefined set of moral values.

18. The computer program product of claim 11, wherein the moral value represents a fairness metric, and wherein evaluating the output from the LM comprises generating a score for the output from the LM, such that the plurality of classifiers generates a plurality of scores for the output.

19. The computer program product of claim 11, wherein the LM is a Large Language Model (LLM) and the input is a user natural language prompt to the LLM.

20. An apparatus comprising:
at least one processor; and
at least one memory coupled to the at least one processor, wherein the at least one memory comprises instructions which, when executed by the at least one processor, cause the at least one processor to:
receive at least one dataset comprising feature representations and corresponding moral values from a predefined set of moral values;
train one or more classifiers based on the at least one dataset, to generate a reward output, thereby generating one or more trained classifiers,
evaluate, by each trained classifier in the one or more trained classifiers, an output from a language model (LM) according to whether the output aligns with one or more moral values corresponding to the trained classifier, to thereby generate one or more corresponding reward outputs;
based on the generated one or more corresponding reward outputs, train at least one moral value agent to generate one or more responses to inputs that are aligned with at least one moral value in the predefined set of moral values; and
generate, for an input, an aligned output that is aligned with a user moral profile based on a processing of the input via the at least one moral value agent, wherein the user moral profile encodes a moral value configuration specifying a user adherence to moral values in the predefined set of moral values.
